(19) United States
(12) Patent Application Publication
(10) Pub. No.: US 2019/0190033 A1
(43) Pub. Date: Jun. 20, 2019

(54) HIGH PERFORMANCE PLATINUM-BASED ELECTROCHEMICAL CATALYSTS

(71) Applicant: THE REGENTS OF THE UNIVERSITY OF CALIFORNIA, Oakland, CA (US)

(72) Inventors: Yu HUANG, Los Angeles, CA (US); Zipeng ZHAO, Los Angeles, CA (US); Xiangfeng DUAN, Los Angeles, CA (US)

(73) Assignee: THE REGENTS OF THE UNIVERSITY OF CALIFORNIA, Oakland, CA (US)

(21) Appl. No.: 16/323,250

(22) PCT Filed: Aug. 3, 2017
(86) PCT No.: PCT/US17/45345

§ 371 Date: Feb. 4, 2019

Related U.S. Application Data
(60) Provisional application No. 62/371,026, filed on Aug. 4, 2016.

(51) Int. Cl. H01M 4/92; H01M 12/08

(52) U.S. Cl. CPC H01M 4/926; H01M 2008/1095; H01M 12/08; H01M 4/921

(57) ABSTRACT

An electrode material includes a catalyst support and Pt—Ni-M-M′ nanostructures affixed to the catalyst support. M is a transition metal different from Pt and Ni, and M′ is a transition metal different from Pt, Ni, and M.

### CROSS-REFERENCE TO RELATED APPLICATION

This application claims the benefit of U.S. Provisional Application No. 62/371,026, filed Aug. 4, 2016, the content of which is incorporated herein by reference in its entirety.

### STATEMENT REGARDING FEDERALLY SPONSORED RESEARCH OR DEVELOPMENT

This invention was made with Government support under DMR1437263, awarded by the National Science Foundation. The Government has certain rights in the invention.

### TECHNICAL FIELD

This disclosure generally relates to electrochemical catalysts and, more particularly, to platinum-based electrochemical catalysts.

### BACKGROUND

Proton-exchange membrane (PEM) fuel cells are desirable energy conversion devices for applications such as transportation vehicles and portable electronic devices, due to their high-energy density and low environmental impact in addition to being light-weight and affording low-temperature operation. PEM fuel cells operate based on reactions of a fuel (such as hydrogen or an alcohol) at an anode and an oxidant (molecular oxygen) at a cathode. Both cathode and anode reactions include catalysts to lower their electrochemical over-potential for high-voltage output, and so far, platinum (Pt) has been the leading choice. To fully realize the commercial viability of fuel cells, the following challenges should be addressed: the high cost of Pt, the sluggish kinetics of the oxygen reduction reaction (ORR), and the low durability of Pt-based catalysts.

It is against this background that a need arose to develop the embodiments described herein.

### SUMMARY

In some embodiments, an electrode material includes a catalyst support and Pt—Ni—M-M′ nanostructures affixed to the catalyst support, where M is a transition metal different from Pt and Ni, and M′ is a transition metal different from Pt, Ni, and M.

In some embodiments of the electrode material, M is Cu. In some embodiments of the electrode material, M′ is a transition metal selected from V, Cr, Mn, Fe, Co, Mo, W, and Re. In some embodiments of the electrode material, M′ is Mo.

In some embodiments of the electrode material, the Pt—Ni—M-M′ nanostructures have an average size up to about 10 nm.

In some embodiments of the electrode material, the catalyst support is a carbon-based support.

In some embodiments of the electrode material, the Pt—Ni—M-M′ nanostructures have a chemical composition represented by a formula: PtₐNi_{b}M_{c}M′_{d} wherein a>h, a>c, a>d, b>d, c>d, and a+b+c+d=100%. In some embodiments of the electrode material, M is selected from Group 11 of the Periodic Table, and M′ is selected from Group 5, Group 6, Group 7, Group 8, and Group 9 of the Periodic Table. In some embodiments of the electrode material, M is Cu, and M′ is Mo. In some embodiments of the electrode material, a has a non-zero value in a range of about 51 to about 85, b has a non-zero value in a range of about 5 to about 49, c has a non-zero value in a range of about 5 to about 49, and d has a non-zero value in a range of 0 to about 8.

In some embodiments, a fuel cell includes an anode, a cathode, and an electrolyte disposed between the anode and the cathode, where the cathode includes the electrode material of any of the foregoing embodiments.

In some embodiments, a metal-air battery includes an anode, a cathode, and an electrolyte disposed between the anode and the cathode, where the cathode includes the electrode material of any of the foregoing embodiments.

In some embodiments, a manufacturing method includes: (1) providing Pt—Ni-M nanostructures in a liquid medium, where M is a transition metal different from Pt and Ni; and (2) reacting a M′-containing precursor, a Pt-containing precursor, a Ni-containing precursor, and a M-containing precursor in the liquid medium to form Pt—Ni-M-M′ nanostructures, where M′ is a transition metal different from Pt, Ni, and M.

In some embodiments of the manufacturing method, providing the Pt—Ni-M nanostructures includes providing the Pt—Ni-M nanostructures affixed to a catalyst support.

In some embodiments of the manufacturing method, M is Cu. In some embodiments of the manufacturing method, M′ is a transition metal selected from V, Cr, Mn, Fe, Co, Mo, W, and Re. In some embodiments of the manufacturing method, M is Cu, and M′ is Mo.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1. Schematic of a fuel cell.

FIG. 2. Schematic of a metal-air battery.

FIG. 3. (A) Scanning transmission electron microscopy (STEM) analysis of Pt—Ni—Cu—Mo nano-octahedra on carbon support. (B) High resolution transmission electron microscopy (HRTEM) analysis of a representative Pt—Ni—Cu—Mo octahedron. (C) X-ray powder diffraction (XRD) of octahedral Pt—Ni—Cu—Mo/C catalyst, with dark perpendicular line indicating a peak position for Pt, and lighter perpendicular line indicated a peak position for Ni. (D) Energy dispersive X-ray spectroscopy (EDS) line scan of a representative Pt—Ni—Cu—Mo octahedron, insert: STEM image of the octahedron for line scan.

FIG. 4. (A) X-ray photoelectron spectroscopy (XPS) analysis of metal elements within octahedral catalyst: (A) Pt, (B) Ni, (C) Cu, and (D) Mo.

FIG. 5. (A) Cyclic voltammetry (CV) curves of Pt—Ni—Cu—Mo/C and Pt/C catalysts. (B) ORR polarization curve of Pt—Ni—Cu—Mo/C and Pt/C catalysts.

### DETAILED DESCRIPTION

Alloying Pt with a secondary metal can reduce the usage of scarce Pt noble metal while at the same time provide improved performance as compared with that of pure Pt in terms of activity. Efforts have been applied towards platinum-nickel (Pt—Ni) nanostructures as ORR catalysts for fuel cell cathode reactions. Pt—Ni catalysts have demonstrated activity ranging to several times that of commercial Pt/C catalysts. However, stability remains an issue in Pt—Ni catalysts. In addition, single crystal study has revealed that bulk Pt₃Ni {111} facet can have an activity of about 18 mA/cm² at about 0.9 V vs. reversible hydrogen electrode (RHE), which is about 90 times compared to commercial Pt/C. However, the single crystal performance has not been matched by nanostructures, indicating room for further improvement. Thus, Pt-based nanostructures with both high catalytic activity and high durability, as well as further reduced usage of scarce Pt, have remained a challenge.

Embodiments of this disclosure are directed to improved Pt-based electrochemical catalysts (or electrocatalysts) for ORR, exhibiting a combination of high activity and high stability, along with reduced usage of scarce Pt. In some embodiments, a Pt-based electrocatalyst is an alloy of Pt, Ni, and at least two additional secondary metals having a chemical composition that can be represented by the formula PtₐNi_{b}M_{c}M′_{d} where any one or any combination of two or more of the following applies: (1) Pt represents platinum as a primary metal; (2) Ni represents nickel as a secondary metal; (3) M represents an additional secondary metal and with M being different from Pt and Ni, such as where M is at least one transition metal selected from Group 3, Group 4, Group 5, Group 6, Group 7, Group 8, Group 9, Group 10, Group 11, and Group 12 of the Periodic Table and with M being different from Pt and Ni; (4) M′ represents a further secondary metal and with M′ being different from Pt, Ni, and M, such as where M′ is at least one transition metal selected from Group 3, Group 4, Group 5, Group 6, Group 7, Group 8, Group 9, Group 10, Group 11, and Group 12 of the Periodic Table and with M′ being different from Pt, Ni, and M; (5) “a” represents a molar content (e.g., expressed as a percentage) of Pt, “b” represents a molar content of Ni, “c” represents a molar content of M, and “d” represents a molar content of M′, with a>b, a>c, and a>d, and also, in some embodiments, b>d and c>d, and also, in some embodiments, b is about the same as c; (6) “a” has a non-zero value in a range of about 51 to about 85, such as about 51 to about 80, about 51 to about 75, about 51 to about 70, or about 51 to about 65; (7) “b” has a non-zero value in a range of about 5 to about 49, such as about 5 to about 40, about 5 to about 35, about 5 to about 30, about 5 to about 25, or about 10 to about 25; (8) “c” has a non-zero value in a range of about 5 to about 49, such as about 5 to about 40, about 5 to about 35, about 5 to about 30, about 5 to about 25, or about 10 to about 25; (9) “d” has a non-zero value in a range of 0 to about 8, such as about 0.1 to about 8, about 0.5 to about 5, about 0.5 to about 3, or about 0.5 to about 2.5; and (10) subject to the condition that a+b+c+d=100 (or 100%).

In some embodiments, M′ is at least one transition metal selected from Group 5, Group 6, Group 7, Group 8, and Group 9 of the Periodic Table. In some embodiments, M′ is one or more of vanadium (V), chromium (Cr), manganese (Mn), iron (Fe), cobalt (Co), molybdenum (Mo), tungsten (W), and rhenium (Re). In some embodiments, M′ is Mo. In some embodiments, M′ is included at a lower molar content relative to Pt, Ni, and M, and can be referred to as a doping element. In some embodiments, M′ is included so as to be localized at or near exterior surfaces to yield a surface-doped electrocatalyst.

In some embodiments, M is at least one transition metal selected from Group 11 of the Periodic Table. In some embodiments, M is copper (Cu). In some embodiments, by introducing Cu (or other M) into a Pt—Ni—Mo (or other Pt—Ni-M′) octahedral catalyst, a resulting PtNiCuMo octahedral catalyst can reach both high activity and stability, along with further reduced usage of scarce Pt noble metal. The mass activity, specific activity, and stability of a Pt—Ni—Cu—Mo catalyst can be higher compared to a Pt—Ni—Mo catalyst.

In some embodiments, a Pt-based electrocatalyst includes multiple nanostructures having the above-noted chemical composition, where any one or any combination of two or more of the following applies: (1) the nanostructures have sizes (or have an average size) in a range of up to about 100 nm, up to about 50 nm, up to about 40 nm, up to about 30 nm, up to about 20 nm, up to about 15 nm, up to about 10 nm, up to about 9 nm, up to about 8 nm, up to about 7 nm, up to about 6 nm, up to about 5 nm, or up to about 4.5 nm, and down to about 4 nm, down to about 3.5 nm, or less; (2) the nanostructures have at least one dimension or extent (or have at least one average dimension or extent) in a range of up to about 100 nm, up to about 50 nm, up to about 40 nm, up to about 30 nm, up to about 20 nm, up to about 15 nm, up to about 10 nm, up to about 9 nm, up to about 8 nm, up to about 7 nm, up to about 6 nm, up to about 5 nm, or up to about 4.5 nm, and down to about 4 nm, down to about 3.5 nm, or less; (3) the nanostructures have aspect ratios (or have an average aspect ratio) in a range of up to about 3, such as about 1 to about 3, about 1 to about 2.5, about 1 to about 2, or about 1 to about 1.5, or in a range of greater than about 3, such as about 4 or greater, about 5 or greater, or about 10 or greater; and (4) the nanostructures are largely or substantially crystalline, such as with a percentage of crystallinity (by volume or weight) of at least about 50%, at least about 60%, at least about 70%, at least about 80%, at least about 90%, at least about 95%, at least about 98%, or at least about 99% or more. Nanostructures of a Pt-based electrocatalyst can have a variety of morphologies, such as in the form of octrahedra having exposed {111} facets, although other morphologies are encompassed by this disclosure, including nanoparticles, nanorods, nanowires, or other elongated nanostructures having aspect ratios greater than about 3, as well as core-shell nanostructures, core-multi-shell nanostructures, and nanoparticle-decorated cores, among others.

In some embodiments, a Pt-based electrocatalyst includes multiple nanostructures that are surface doped with M′, such that at least a majority (e.g., by weight, moles, or number) of M′ atoms are located within a depth of 5 atomic layers from an exterior of a nanostructure, such as within 4 atomic layers, within 3 atomic layers, or within 2 atomic layers. In some embodiments, at least a majority (e.g., by weight, moles, or number) of M′ atoms are in an oxidized state.

In some embodiments, a Pt-based electrocatalyst includes multiple nanostructures that are loaded on, dispersed in, affixed to, anchored to, or otherwise connected to a catalyst support, such as carbon black. In place of, or in combination with, carbon black, another catalyst support having suitable electrical conductivity can be used, such as another carbon-based support in the form of graphene, carbon fiber paper, or carbon cloth, as well as metallic foams, among others. A combination of a Pt-based electrocatalyst loaded on a catalyst support can be referred to as an electrode material. A Pt-based electrocatalyst can be loaded on multiple supports, including a primary support, such as a two-dimensional support, along with a secondary support, such as to provide desired spacing between or mitigate against stacking of the primary support. The electrocatalyst should be well dispersed on the two-dimensional, primary support, and conductivity of both primary and secondary supports should be adequate for improved performance.

In some embodiments, a Pt-based electrocatalyst can be formed according to a manufacturing method including: (1) providing a dispersion of Pt—Ni-M nanostructures affixed to a catalyst support in a liquid medium; and (2) reacting a M′-containing precursor, a Pt-containing precursor, a Ni-containing precursor, and a M-containing precursor in the liquid medium to form Pt—Ni-M-M′ nanostructures.

In some embodiments, providing the dispersion in (1) includes reacting a Pt-containing precursor (which can be the same as or different from the Pt-containing precursor used in (2)), a Ni-containing precursor (which can be the same as or different from the Ni-containing precursor used in (2)), and a M-containing precursor (which can be the same as or different from the M-containing precursor used in (2)) in the presence of the catalyst support in the liquid medium to form the dispersion of Pt—Ni-M nanostructures affixed to the catalyst support. Suitable Pt-containing precursors (used in (1) and (2)) include an organometallic coordination complex of Pt with an organic anion, such as acetylacetonate, suitable Ni-containing precursors (used in (1) and (2)) include an organometallic coordination complex of Ni with an organic anion, such as acetate, and suitable M-containing precursors (used in (1) and (2)) include an organometallic coordination complex of M with an organic anion, such as acetate. The liquid medium includes one or more solvents, such as one or more organic solvents selected from polar aprotic solvents, polar protic solvents, and non-polar solvents. In some embodiments, a solvent included in the liquid medium also can serve as a reducing agent for reduction of Pt, Ni, and M, although the inclusion of a separate reducing agent is also contemplated. In some embodiments, a structure-directing agent, such as benzoic acid or other aromatic carboxylic acid, is also included in the liquid medium to promote a desired morphology of Pt—Ni-M nanostructures. Reaction can be carried out under agitation and under conditions of a temperature in a range of about 100° C. to about 300° C. or about 100° C. to about 250° C., and a time duration in a range of about 2 hours to about 24 hours or about 6 hours to about 18 hours.

In some embodiments, reacting in (2) includes adding or otherwise incorporating the M′-containing precursor, the Pt-containing precursor (which can be the same as or different from the Pt-containing precursor used in (1)), the Ni-containing precursor (which can be the same as or different from the Ni-containing precursor used in (1)), and the M-containing precursor (which can be the same as or different from the M-containing precursor used in (1)) to the liquid medium. Suitable M′-containing precursors include an organometallic coordination complex of M′ with an organic anion, such as carbonyl. Reaction can be carried out under agitation and under conditions of a temperature in a range of about 100° C. to about 300° C. or about 100° C. to about 250° C., and a time duration in a range of about 12 hours to about 60 hours or about 24 hours to about 60 hours. The resulting (freshly prepared) electrocatalyst can be kept in a sealed container for long-term preservation.

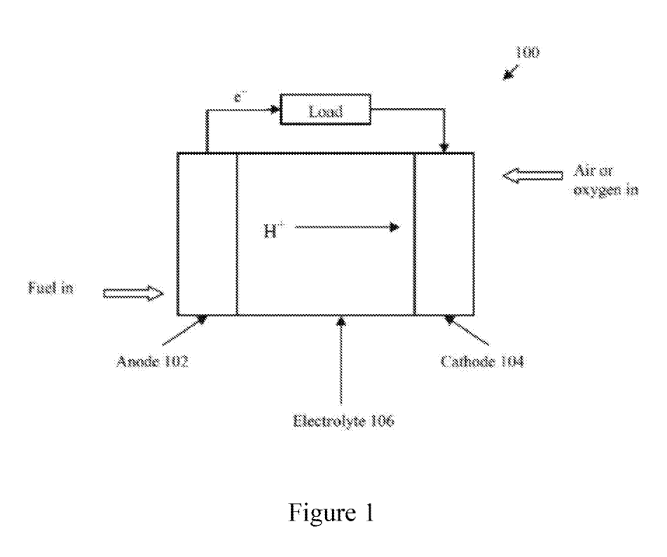

FIG. 1 is a schematic of a fuel cell 100 according to some embodiments of this disclosure. The fuel cell 100 includes an anode 102, a cathode 104, and an electrolyte 106 that is disposed between the anode 102 and the cathode 104. In the illustrated embodiments, the fuel cell 100 is a PEM fuel cell, in which the electrolyte 106 is implemented as a proton-exchange membrane, such as one formed of polytetrafluoroethylene or other suitable fluorinated polymer. During operation of the fuel cell 100, a fuel (such as hydrogen or an alcohol) is oxidized at the anode 102, and oxygen is reduced at the cathode 104. Protons are transported from the anode 102 to the cathode 104 through the electrolyte 106, and electrons are transported over an external circuit load. At the cathode 104, oxygen reacts with the protons and the electrons, forming water and producing heat. Either one, or both, of the anode 102 and the cathode 104 can include an electrocatalyst as set forth in this disclosure. For example, the cathode 104 can include a Pt—Ni—Cu—Mo electrocatalyst.

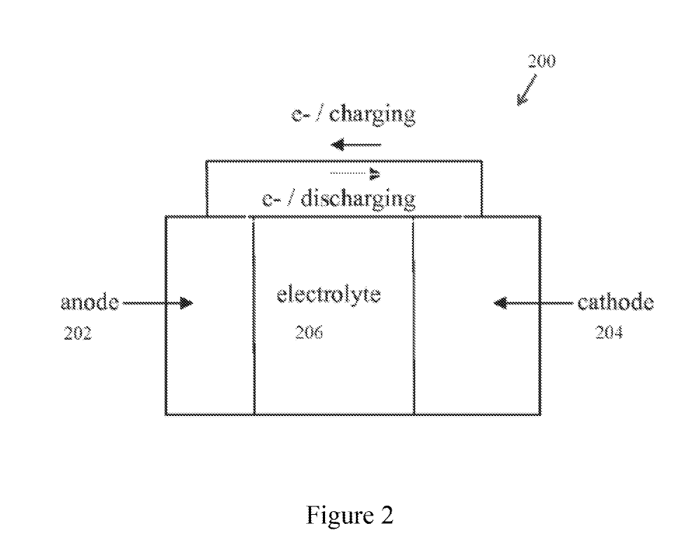

FIG. 2 is a schematic of a metal-air battery 200 according to some embodiments of this disclosure. The battery 200 can operate based on oxidation of lithium at an anode 202 and reduction of oxygen at a cathode 204 to induce a current flow. In the case of a Li-air battery, the anode 202 includes lithium metal, although other metals (e.g., zinc) can be included in place of, or in combination with, lithium metal. An electrolyte 206 is disposed between the anode 202 and the cathode 204, and can be an aprotic electrolyte, although other types of electrolytes are contemplated, such as aqueous, solid state, and mixed aqueous/aprotic electrolytes. The cathode 204 can include an electrocatalyst as set forth in this disclosure. For example, the cathode 204 can include a Pt—Ni—Cu—Mo electrocatalyst.

### EXAMPLE

The following example describes specific aspects of some embodiments of this disclosure to illustrate and provide a description for those of ordinary skill in the art. The example should not be construed as limiting this disclosure, as the example merely provides specific methodology useful in understanding and practicing some embodiments of this disclosure.

### Methods and Results

1. Example Synthesis of Pt—Ni—Cu—Mo Octahedra on Carbon Support and Characterization.

About 10-30 mg Vulcan XC-72 carbon black was dispersed in about 8-10 mL N,N-dimethylformamide (DMF) under ultrasonication for about 30 mins in a 25 mL vial. Then about 7-9 mg platinum(II) acetylacetonate [Pt(acac)₂], about 3-5 mg nickel(II) acetate tetrahydrate [Ni(ac)₂·4H₂0], and about 2 mg copper(II) acetate [Cu(ac)₂·H₂0], and about 60-75 mg benzoic acid were dissolved in about 1 ml DMF and were also added into the 25 ml vial with the carbon black dispersion. After ultrasonication for about 5 mins, the vial with well mixed solution was directly placed into an about 130-150° C. oil bath, and then slowly heated to about 160-170° C. within about 2 hrs. The vial was kept at about 160-170° C. for about 12-15 hrs.

After about 12-15 his, about 1-3 mg Pt(acac)₂, about 0.5-2 mg Ni(ac)₂·4H₂0, about 0.2-1 mg Cu(ac)₂·H₂0, about 0.3-0.6 mg molybdenum(0) hexacarbonyl [Mo(CO)₆], and about 30 mg citric acid were dissolved in about 0.5-1.5 mL DMF and were added into the vial. Then the vial was kept in an about 160-180° C. oil bath for about 48 hrs. After completion of reaction, resulting catalysts were collected by centrifugation, and then re-dispersed and washed with isopropanol and acetone mixture, then washed with water, then isopropanol and acetone mixture again. Then the catalysts were dried in vacuum at room temperature and ready for characterization and electrochemistry testing.

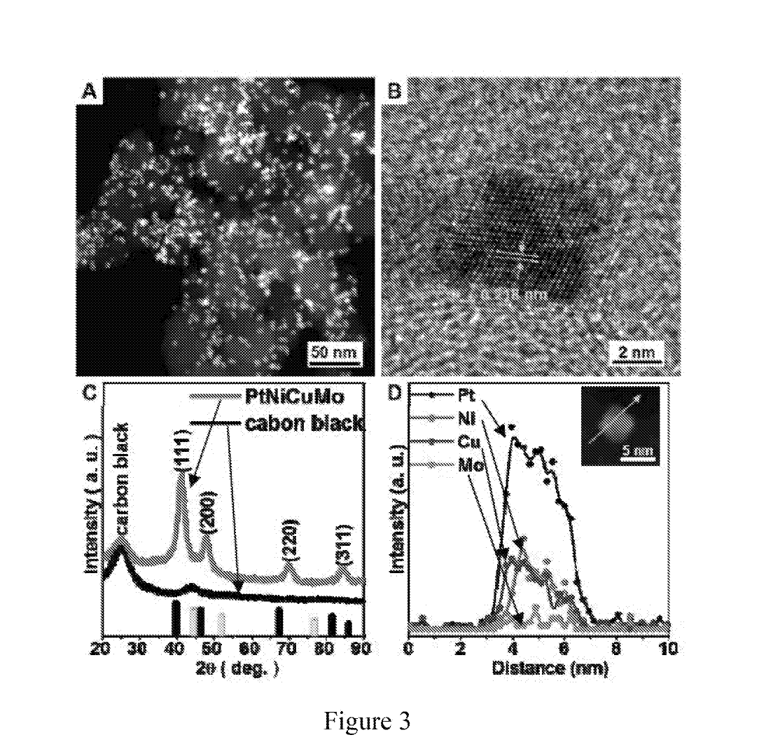

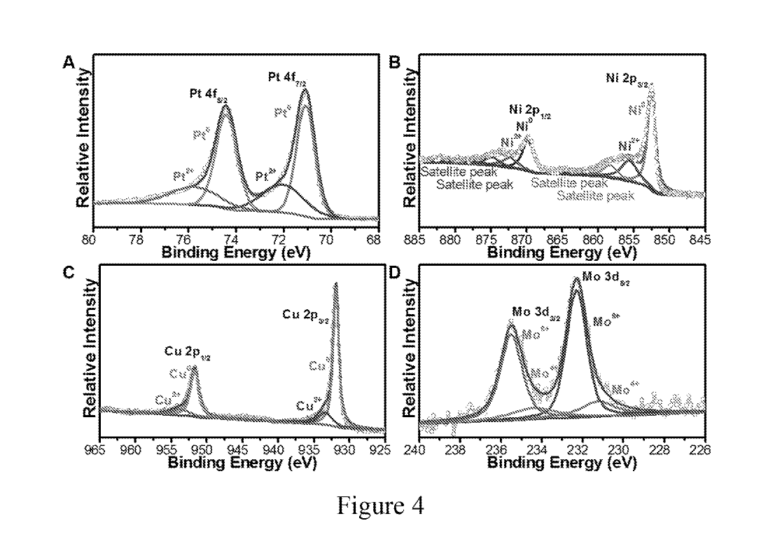

Scanning transmission electron microscopy (STEM) analysis showed synthesized alloy nanostructures with an octahedral morphology, with edge length of 4.6±0.6 nm and being well distributed on carbon support (FIG. 3A). High resolution transmission electron microscopy (HRTEM) analysis showed an {111} interplanar distance of about 0.218 nm which indicated a lattice parameter of about 0.378 nm (FIG. 3B). X-ray powder diffraction (XRD) analysis indicated an alloy structure with a face center cubic lattice and a lattice parameter of about 0.378 nm, which matched well with the HRTEM result (FIG. 3C). Energy dispersive X-ray spectroscopy (EDS) line scan showed Pt, Ni, and Cu are substantially uniformly distributed within an octahedral structure and with Mo close to the EDS detection limit (FIG. 3D). EDS and inductively coupled plasma atomic emission spectroscopy (ICP-AES) analysis showed an atomic composition of the nanocatalyst is: Pt-about 55-65%, Ni—about 17.5-22.5%, Cu—about 17.5-22.5%, and Mo—about 1.0-1.8%. X-ray photoelectron spectroscopy (XPS) analysis showed Pt, Ni, and Cu were mainly in their zero valance state, while Mo was mainly in the Mo(6+) oxidation state (FIG. 4).
2. Electrochemistry Test.

Pt—Ni—Cu—Mo/C catalyst ink was prepared by dissolving catalyst in ethanol and Nafion mixture. Typically, about 2.4 mg of catalyst was dispersed in about 2 mL ethanol mixed with about 20 μL of 5% Nafion solution. Typically, the Pt loading on rotating disk electrode (RDE) was about 1.7 μg, and RDE electrode diameter was about 0.5 cm, which corresponds to about 0.196 cm² as surface area.

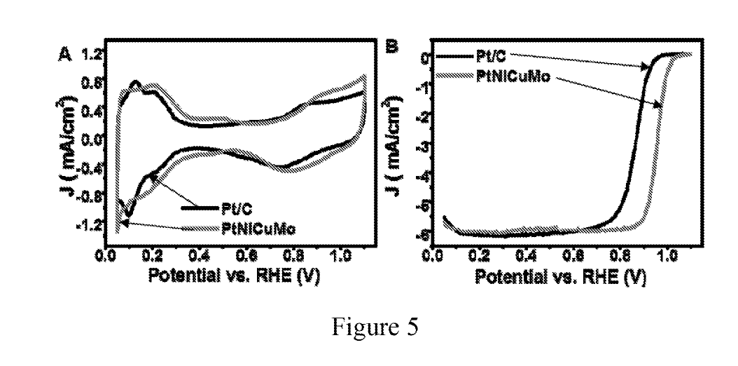

Cyclic voltammetry (CV) curves of Pt—Ni—Cu—Mo catalyst was obtained in N₂-saturated about 0.1 M HClO₄ from about 0.05 to about 1.1 V vs. reversible hydrogen electrode (RHE) with a scan rate of about 100 mV/s (see FIG. 5A). And oxygen reduction reaction (ORR) activity was tested in about O₂-saturated about 0.1 M HClO₄ with a scan rate of about 20 mV/s from about 0.05 to about 1.1 V vs. RHE under about 1600 rpm rotating speed (see FIG. 5B). Accelerated degradation test (ADT) was carried in O₂-saturated about 0.1 M HClO₄ with cyclic scan from about 0.6 to about 1.0 V at a scan rate of 100 mV/s,

The Pt—Ni—Cu—Mo catalyst showed outstanding specific activity (SA) (based on hydrogen underpotential deposition (Hupd)) of 9.9±0.7 mA/cm² and mass activity (MA) of 5.3±0.3 mA/μg_{Pt}, which were about 25.4 times and about 18.9 times compared to the specific activity and mass activity of Pt/C (SA: 0.39±0.05 mA/cm²; MA: 0.28±0.03 mA/μg_{Pt}), respectively (Table 1). In ADT, octahedral Pt—Ni—Mo—Cu/C also showed very high stability, maintaining about 74.0% of its specific activity and about 83.0% of its mass activity after 15,000 ADT cycles (Table 1).

TABLE 1
Activity comparison of Pt/C and Pt—Ni—Cu—Mo before and
after 15,000 ADT cycles.

| | Specific Activity | |
|---|---|---|
| | (mA/cm²) | Mass Activity |
| | based on Hupd | (mA/μg_{Pt}) |
| Pt/C | 0.39 ± 0.05 | 0.28 ± 0.03 |
| PtNiCuMo/C | 9.9 ± 0.7 | 5.3 ± 0.3 |
| PtNiCuMo/C | 74.0% | 83.0% |
| Initial Activity | | |
| Retention After 15k | | |
| ADT cycles | | |

As used herein, the singular terms “a,” “an,” and “the” may include plural referents unless the context clearly dictates otherwise. Thus, for example, reference to an object may include multiple objects unless the context clearly dictates otherwise.

As used herein, the term “set” refers to a collection of one or more objects. Thus, for example, a set of objects can include a single object or multiple objects.

As used herein, the terms “connect,” “connected,” and “connection” refer to an operational coupling or linking Connected objects can be directly coupled to one another or can be indirectly coupled to one another, such as via one or more other objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be substantially or about the same as a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the term “size” refers to a characteristic dimension of an object. Thus, for example, a size of an object that is spherical can refer to a diameter of the object. In the case of an object that is non-spherical, a size of the non-spherical object can refer to a diameter of a corresponding spherical object, where the corresponding spherical object exhibits or has a particular set of derivable or measurable properties that are substantially the same as those of the non-spherical object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

Additionally, concentrations, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a range of about 1 to about 200 should be understood to include the explicitly recited limits of about 1 and about 200, but also to include individual values such as about 2, about 3, and about 4, and sub-ranges such as about 10 to about 50, about 20 to about 100, and so forth.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations are not a limitation of the disclosure.

What is claimed is:

1. An electrode material comprising:
a catalyst support; and
Pt—Ni-M-M′ nanostructures affixed to the catalyst support,
wherein M is a transition metal different from Pt and Ni, and M′ is a transition metal different from Pt, Ni, and M.

2. The electrode material of claim 1, wherein M is Cu.

3. The electrode material of claim 2, wherein M′ is a transition metal selected from V, Cr, Mn, Fe, Co, Mo, W, and Re.

4. The electrode material of claim 3, wherein M′ is Mo.

5. The electrode material of claim 1, wherein the Pt—Ni-M-M′ nanostructures have an average size up to about 10 nm.

6. The electrode material of claim 1, wherein the catalyst support is a carbon-based support.

7. The electrode material of claim 1, wherein the Pt—Ni-M-M′ nanostructures have a chemical composition represented by a formula: PtₐNi_{b}M_{c}M′_{d} wherein a>b, a>c, a>d, b>d, c>d, and a+b+c+d=100%.

8. The electrode material of claim 7, wherein M is selected from Group 11 of the Periodic Table, and M′ is selected from Group 5, Group 6, Group 7, Group 8, and Group 9 of the Periodic Table.

9. The electrode material of claim 8, wherein M is Cu, and M′ is Mo.

10. The electrode material of claim 8 or 9, wherein:
a has a non-zero value in a range of about 51 to about 85;
b has a non-zero value in a range of about 5 to about 49;
c has a non-zero value in a range of about 5 to about 49; and
d has a non-zero value in a range of 0 to about 8.

11. A fuel cell comprising:
an anode;
a cathode; and
an electrolyte disposed between the anode and the cathode,
wherein the cathode includes the electrode material of claim 1.

12. A metal-air battery comprising:
an anode;
a cathode; and
an electrolyte disposed between the anode and the cathode,
wherein the cathode includes the electrode material of claim 1.

13. A manufacturing method comprising:
providing Pt—Ni-M nanostructures in a liquid medium, wherein M is a transition metal different from Pt and Ni; and
reacting a M′-containing precursor, a Pt-containing precursor, a Ni-containing precursor, and a M-containing precursor in the liquid medium to form Pt—Ni-M-M′ nanostructures, wherein M′ is a transition metal different from Pt, Ni, and M.

14. The manufacturing method of claim 13, wherein providing the Pt—Ni-M nanostructures includes providing the Pt—Ni-M nanostructures affixed to a catalyst support.

15. The manufacturing method of claim 13, wherein M is Cu.

16. The manufacturing method of claim 13, wherein M′ is a transition metal selected from V, Cr, Mn, Fe. Co, Mo, W, and Re. 17, The manufacturing method of claim 13, wherein M is Cu, and M′ is Mo.
